(19) United States
(12) Patent Application Publication
(10) Pub. No.: US 2026/0243613 A1
(43) Pub. Date: Aug. 20, 2026

(54) IONTRONIC PRESSURE SENSOR WITH ULTRA-BROAD LINEARITY RANGE AND HIGH SENSITIVITY ENABLED BY LASER-INDUCED GRADIENT PYRAMIDAL STRUCTURES

(71) Applicant: The Penn State Research Foundation, University Park, PA (US)

(72) Inventor: Huanyu Cheng, University Park, PA (US)

(73) Assignee: The Penn State Research Foundation, University Park, PA (US)

(21) Appl. No.: 19/164,896

(22) PCT Filed: Apr. 30, 2024
(86) PCT No.: PCT/US2024/026939

§ 371 Date: Sep. 12, 2025

Related U.S. Application Data
(60) Provisional application No. 63/499,292, filed on May 1, 2023.

(51) Int. Cl. G01L 1/14; B23K 26/36

(52) U.S. Cl. CPC G01L 1/142; B23K 26/36

(57) ABSTRACT

Embodiments relate to an apparatus including a capacitive iontronic pressure sensor and methods of making and using thereof. The sensor comprises a top electrode layer including a first electrode attached to a substrate, a bottom electrode layer including a second electrode having a plurality of pyramidal microstructures, and a dielectric layer including an ionic gel and positioned between the first electrode and the second electrode. The plurality of pyramidal microstructures forms a gradient array on the second electrode.

### CROSS-REFERENCE TO RELATED APPLICATIONS

This application claims priority to U.S. Provisional Patent Application No. 63/499,292, which was filed on May 1, 2023. The entirety of this application is incorporated by reference herein.

### STATEMENT REGARDING FEDERALLY SPONSORED RESEARCH DEVELOPMENT

This invention was made with government support under Grant Nos. HL154215, EB030140, DA056242, and OH012220 awarded by the National Institutes of Health and under Grant Nos. ECCS 1933072 and 2222654 awarded by the National Science Foundation. The Government has certain rights in the invention.

### FIELD OF THE INVENTION

Embodiments relate to an apparatus including a capacitive pressure sensor, particularly to a capacitive iontronic pressure sensor utilizing pyramidal microstructures to achieve high sensitivity over a broad linear range, high pressure resolution under a large preload, and a low detection limit, among other advantageous properties, and methods of making and using thereof.

### BACKGROUND OF THE INVENTION

The rapid development of flexible pressure sensors have spurred new opportunities for robotics, prosthetic, human-machine interface, and health monitoring. Compared with piezoelectric and piezoresistive pressure sensors, capacitive pressure sensors are simple in structure, highly stable with low drift, and have low power consumption. The practical applications of capacitive pressure sensors hinge on their sensing performance especially high sensitivity and linearity over a broad range for easy signal processing. Among varying microstructures such as micro-dome and hierarchical fabrics, the pyramidal structures exhibit excellent compressibility and progressive deformation with increasing pressure to result in high sensitivity in a large linear range. Photolithography-based approaches have been mainly used to investigate the effects of various geometric parameters (e.g., sidewall angle, density, and frustum top/base length). However, the high sensitivity drastically decreases as the pressure further increases (to completely deform the pyramidal microstructures). There are opportunities to exploit non-uniformly distributed (e.g., gradient) microstructures, but the complex and expensive processes present challenges to exploring and optimizing the parameter space. As a result, microstructures have been templated from natural/existing objects (e.g., leaf, abrasive paper, petal, and fabric), but the random microstructures result in uncontrollable deformation and narrow linear range. Therefore, it is important to design microstructure patterns and/or varying permittivities at different microstructure locations for increased linear range, though often at an expense of decreased sensitivity.

Besides modulating the overlapping area and the distance between two electrodes in the capacitive pressure sensor, it is of high interest to explore high dielectric materials for improved dielectric properties and increased sensitivity. Although much effort is devoted to mixing high dielectric materials with nanomaterials, the sensitivity of the capacitive pressure sensors is far from their piezoresistive counterparts. Atomically thin ionic liquids (ILs) layers (~1 nm) between positive and negative charges in the electron double layer (EDL) at the electrode/dielectric interface can significantly increase the piezo-capacitive effect. The EDL effect can be affected by the concentration of the ILs and the measurement frequency. Mixing ILs with high-polarity polymers to form a dielectric layer helps enhance the sensitivity of the microstructured pressure sensors. Using electrode materials with ions intercalation-based pseudocapacitance in iontronic sensors can also enhance the capacitance and then the sensitivity. However, such high sensitivity is often limited to a small linear sensing range, with the sensitivity declining gradually as the pressure loading further increases.

High linearity over a broad sensing range usually comes at a cost of reduced sensitivity. The development of capacitive pressure sensors with high sensitivity in a wide linear range remains elusive due to the trade-off between sensitivity and linear range. Efforts to address this challenge lead to the exploration of various structure designs in iontronic sensors. Despite rapid developments, fabrication of the critical microstructures still relies on complex fabrication processes such as photolithography or transferring of random microstructures. Therefore, there is an urgent demand for an effective and efficient fabrication method to prepare the programmable microstructure designed by quantitative numerical analysis.

### SUMMARY OF THE INVENTION

Despite the extensive developments of flexible capacitive pressure sensors, it is still elusive to simultaneously achieve excellent linearity over a broad pressure range, high sensitivity, and ultrahigh pressure resolution under large pressure preloads. We have found that leveraging the Gaussian power distribution of a CO₂ laser may be used to provide a scalable manufacturing method to fabricate an apparatus including flexible iontronic pressure sensors based on programmable gradient pyramidal microstructures. The combination of a gradient pyramidal microstructure electrode and a nanoscale ultrathin IL layer may allow for the formation of EDLs at the IL/electrode interface, which contributes to a high sensitivity and excellent linearity over a broad linear sensing range, high pressure resolution under a large preload, and a low detection limit. Modulation of the pyramidal profiles in the gradient pyramidal microstructure electrode and the concentration of IL layer further may enhance the capacitive pressure sensing performance to result in an ultrahigh sensitivity. Additionally, the fine features on the gradient pyramidal microstructure electrode surface may provide minimized initial contact area for the sensor to detect an ultralow pressure. Taken together with rapid response/recovery and excellent repeatability, the pressure sensor may be used in a wide range of applications.

In an exemplary embodiment, a capacitive iontronic pressure sensor comprises a top electrode layer comprising a first electrode attached to a substrate; a bottom electrode layer comprising a second electrode, wherein the second electrode comprises a plurality of pyramidal microstructures; and a dielectric layer positioned between the first electrode and the second electrode and comprising an ionic gel, wherein the plurality of pyramidal microstructures forms a gradient array on the second electrode.

In some embodiments, the gradient array comprises a first area of pyramidal microstructures having a first height; and a second area of pyramidal microstructures having a second height, wherein the first height is different than the second height.

In some embodiments, the gradient array comprises a first area of pyramidal microstructures having a first height; a second area of pyramidal microstructures having a second height; and a third area of pyramidal microstructures having a third height, wherein each of the first height, the second height, and the third height are different.

In some embodiments, each pyramidal microstructure comprises a multi-layered structure.

In some embodiments, each pyramidal microstructure comprises an outermost region of a first height; an intermediate region with a second height; and an innermost region with a third height, wherein the first height is less than the second height, and the second height is less than the third height.

In some embodiments, the second electrode further comprises a metal sputtering layer formed on the plurality of pyramidal microstructures.

In some embodiments, the metal sputtering layer comprises gold.

In some embodiments, the sensor has a sensitivity of 33.7 kPa⁻¹ over a linear range of 1700 kPa.

In some embodiments, the sensor has a detection limit of 0.36 Pa.

In some embodiments, the sensor has a pressure resolution of 0.00725%.

In some embodiments, the sensor has a response time between 30-50 milliseconds.

In some embodiments, the first electrode comprises an indium tin oxide material.

In some embodiments, the second electrode comprises a PDMS material.

In an exemplary embodiments, an electronic sensing device comprises a microcontroller unit; at least one sensor as described above; a non-transitory computer readable medium connected to the microcontroller unit; a transceiver unit connected to the microcontroller unit; and a power source.

In some embodiments, the electronic sensing device is configured to transmit collected data to an input/output device.

In an exemplary embodiment, a method of making a capacitive iontronic pressure sensor comprises forming a second electrode. Forming a second electrode comprises laser-ablating a second electrode template to form a plurality of cell units within the template, wherein the plurality of cell units forms a gradient array, laser-ablating each cell unit to correspond to a pyramidal shape, filling the second electrode template with a second electrode material, and removing the second electrode material from the second electrode template to form the second electrode. The method further comprises coating a first electrode with an ionic gel to form a dielectric layer; and positioning the dielectric layer between the first electrode and the second electrode layer to form the sensor.

In some embodiments, the gradient array comprises a first area of cell units having a first depth; and a second area of cell units having a second depth, wherein the first depth is different than the second depth.

In some embodiments, the gradient array comprises a first area of cell units having a first depth; a second area of cell units having a second depth; and a third area of cell units having a third depth, wherein each of the first depth, the second depth, and the third depth are different.

In some embodiments, the pyramidal shape comprises a multi-layered shape.

In some embodiments, each cell unit comprises an outermost region of a first depth; an intermediate region with a second depth; and an innermost region with a third depth, wherein the first depth is less than the second depth, and the second depth is less than the third depth.

In some embodiments, the method further comprises forming a metal sputtering layer on the second electrode.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 is a schematic view of an exemplary embodiment of a sensor.

FIG. 2 shows an exemplary embodiment of a method of forming a sensor.

FIGS. 3A-3C are block diagrams illustrating exemplary embodiments of systems implementing the sensor.

FIG. 3D is a schematic block diagram of exemplary electrical components an exemplary sensor.

FIG. 4 is a schematic showing an exemplary method of forming a sensor.

FIG. 5 is a schematic showing exemplary top and side views of an exemplary pyramidal microstructure of a polymethyl methacrylate (PMMA) mold.

FIG. 6 is a schematic showing an exemplary embodiment of a sensor.

FIG. 7 shows scanning electron microscopy (SEM) images of an exemplary second electrode in side, top, and perspective views.

FIG. 8 shows optical images of exemplary second electrode in tilt and top views.

FIG. 9 is a graph showing a comparison of the pressure sensing performance between the sensors with different microstructures (20 wt % ionic gel). (UPM: uniform pyramidal microstructures; GPM: gradient pyramidal microstructures; GPML or GPMS: gradient pyramidal microstructures with large or small height differences; the subscript represents the base length of laser-ablated patterns).

FIG. 10 is a graph showing a comparison of the pressure sensing performance between the sensors with different ionic gel weight percentages.

FIG. 11 is a schematic showing application of an exemplary sensor in health monitoring.

FIG. 12 is a schematic showing application of an exemplary sensor with a smart weight scale.

FIG. 13 is a schematic showing application of an exemplary sensor with an interactive robotic hand.

FIG. 14 are graphs showing capacitance responses from two sensors on robotic fingers during handling an object with a zoom-in view shown in the inset (ionic gel of 50 wt %).

FIG. 15 shows an exemplary operating mechanism of the robotic hand, including a circuit diagram of the robotic hand with two iontronic pressure sensors, and a schematic diagram showing the use of the proportion-integration-differentiation (PID) system to control the robotic hand based on the capacitance measurements C₀/C₁ from the iontronic pressure sensor on the thumb/index finger. C_{b} and C_{L} are the boot thresholds of the sensor on the thumb and index finger, respectively. θ is the rotation of the motor for the robotic finger with θₜ for the present value. C₁ₛₑₜₚₒᵢₙₜ is the desired value and its difference with C₁ is noted as error.

FIG. 16 shows a comparison between microstructures obtained from two PMMA templates that were separately created by using the same laser parameters, demonstrating reasonably good consistency in the morphology (e.g., height, outline, and surface topography).

FIG. 17 includes SEM images showing conical frustums, cone, and square frustums microstructures.

FIG. 18 includes optical images showing the microstructures with higher aspect ratios as the laser power increases (fabricated with the square pattern).

FIG. 19 is a schematic showing the buckling of the slender microstructures upon pressure loading.

FIG. 20 is a schematic showing the deformation of a square frustum upon pressure loading.

FIG. 21 includes SEM images showing the pyramidal structures with different sizes: 700 μm and 500 μm in the unit cell, as well as the failed pyramid created by three square patterns with a small difference.

FIG. 22 is a schematic showing the top and side views of the laser-ablating patterns for creating the PMMA mold.

FIG. 23 includes SEM images showing gradient pyramidal microstructures from the top and side views.

FIG. 24 shows stress distribution results from finite element analysis.

FIG. 25 is a graph showing normalized relative contact area change (ΔA/A₀) at the electrode/ionic gel interface under pressure loading on the sensor with varying (uniform and gradient) microstructures.

FIG. 26 is a graph showing experimental validation of the normalized relative capacitance change from the pressure sensor based on uniform microstructures (ionic gel of 20 wt %).

FIG. 27 is a graph showing experimental validation of the normalized relative capacitance change from the pressure sensor based on gradient microstructures (ionic gel of 20 wt %).

FIG. 28 is a graph showing dependence of the areal capacitance on the measurement frequency for the dielectric layer with different ionic gel concentrations (20, 30, and 50 wt %).

FIG. 29 is a graph showing changes in the capacitance with increasing pressure up to 8 kPa at measurement frequencies of 1 kHz, 10 kHz, 100 kHz, and 1 MHz (IL of 20 wt %).

FIG. 30 shows nonuniform electric potential distribution in GPML₅₀₀ and GPML₇₀₀ before and after pressure loading.

FIG. 31 is a graph showing simulation of the electric field in the GPML with varying ionic gel concentrations and the highly non-linear electric field across the space between the first and microstructured second electrodes.

FIG. 32 is a graph showing responses of the sensors based on GPML₅₀₀ with various weight percentages of ionic gels.

FIG. 33 illustrates side-view SEM images showing the difference in the size of pyramids between GPML₅₀₀ and GPML₇₀₀.

FIG. 34 shows a comparison in the potential distribution between the uniform (top) and gradient (bottom) structures.

FIG. 35 is a graph showing the normalized relative capacitance changes as a function of the applied pressure between the gradient and uniform structures, with a 220-fold increase in the sensitivity for the gradient structure.

FIG. 36 is a graph showing responses of the sensors based on GPML₇₀₀ with various weight percentages of ionic gels.

FIG. 37 is an optical image of the iontronic sensor bent over a diameter of 13 mm.

FIG. 38 is a graph showing the pressure sensing performance of the configuration shown in FIG. 37.

FIG. 39 is a schematic diagram of the iontronic pressure sensor under different bending conditions.

FIG. 40 is a graph showing a typical response curve of the iontronic pressure sensor operated at 1 kHz for the calculation of the response/recovery time.

FIG. 41 is a top-view SEM image showing the rough surface on the tip of a single pyramidal microstructure.

FIG. 42 is a graph demonstrating the detection limit of 0.36 Pa with repeated loading of a small piece of weighing paper on the sensor.

FIG. 43 is a graph showing detection of the additionally applied small pressure (from a weight of 1 g, 2 g, 10 g) under an existing preload pressure of 2 kg.

FIG. 44 is a graph showing repeatability test of the sensor to a cycling pressure load of ca. 800 kPa over 4,500 cycles.

FIG. 45 is a graph showing response from three different pressure sensors.

FIG. 46 shows thumb pulse measurements from the healthy human subject in rest and after exercise.

FIG. 47 shows measurement of mouse movements for static and dynamic pressure detection, including single/double/triple clicks and hold-and-drag operation (ionic gel of 35 wt %).

FIG. 48 shows capacitive response of the sensor under the chair to the volunteer of different weights, compared to the measurements from the commercial weight scale.

FIG. 49 shows a simulation of the electric field in the GPML with varying ionic gel concentrations.

FIG. 50 shows various designs of laser ablation patterns for varying microstructures.

### DETAILED DESCRIPTION OF THE INVENTION

The following description is of exemplary embodiments and methods of use that are presently contemplated for carrying out the present invention. This description is not to be taken in a limiting sense, but is made merely for the purpose of describing the general principles and features of various aspects of the present invention. The scope of the present invention is not limited by this description.

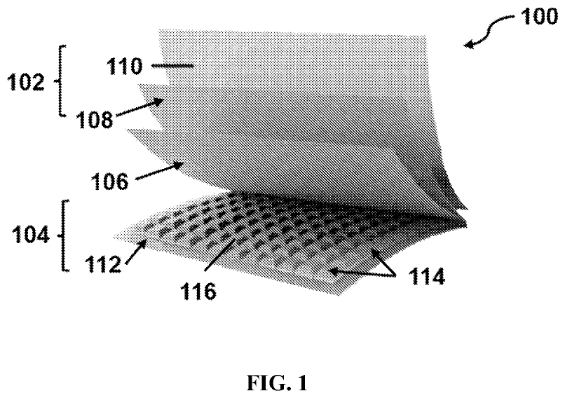

As seen in FIG. 1, embodiments generally relate to an apparatus including at least one capacitive iontronic pressure sensor 100. The sensor 100 includes a top electrode layer 102, a bottom electrode layer 104, and a dielectric layer 106 positioned between the top electrode layer 102 and the bottom electrode layer 104. The sensor 100 may be configured to measure pressure or changes in pressure applied to the sensor 100 by detecting changes in electrical capacitance. In general, when pressure is applied to the sensor 100, the top electrode layer 102 may move (e.g., bend) and a change in capacitance may be created. The change in capacitance may then be translated into an electrical signal and analyzed via an electronic device, module (e.g., a processing module), etc. of the apparatus.

The top electrode layer 102 includes a first electrode 108 formed on a substrate 110, wherein the substrate 110 may form an external surface of the sensor 100. For example, the substrate 110 may be configured to be in contact with an external pressure load such that any resulting pressure or pressure change may be detected by the sensor 100. The substrate 110 may be any suitable material. In preferred embodiments, the substrate 110 may be a flexible material, such as polyethylene terephthalate (PET). In preferred embodiments, the first electrode 108 may be formed from a flexible material. It is contemplated that the first electrode 108 may be formed from a conductive material, such as metals or nanocomposites with conductive fillers. In some embodiments, the first electrode 108 is formed from an indium tin oxide (ITO) material.

The bottom electrode layer 104 includes a second electrode 112. The second electrode 112 may be a fixed electrode. For example, the second electrode layer 102 may be fixed to a structure or object and not configured to be in contact with an external pressure load. In preferred embodiments, the second electrode 112 may be formed from a flexible material. It is contemplated that the second electrode 112 may be formed from a material such as silicone rubbers, hydrogels, polymers, resins, and/or mixtures thereof. In some embodiments, the second electrode 108 is formed from a polydimethylsiloxane (PDMS) material. The second electrode 112 includes a plurality of microstructures 114, such as an array of microstructures 114, formed on one of its surfaces (e.g., the dielectric layer-facing surface). In preferred embodiments, the microstructures 114 may be gradient pyramidal microstructures. It is contemplated that gradient pyramidal microstructures may advantageously exhibit excellent compressibility and progressive deformation with increasing pressure loads to result in a sensor 100 with high sensitivity in a large linear range.

It is contemplated that a density of microstructures 114 on the second electrode 112 may be 100-1000 microstructures per 1 cm², preferably 144-256 microstructures per 1 cm².

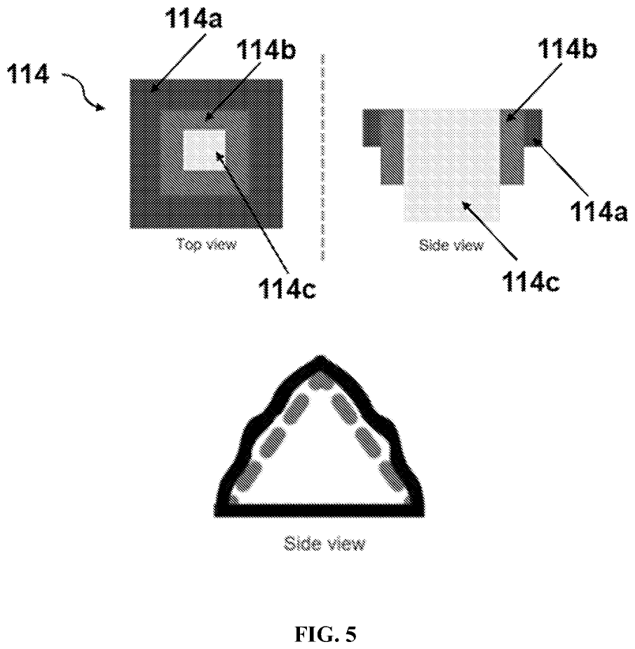

In some embodiments, the microstructures 114 are multi-layer pyramidal microstructures (see, e.g., mold of FIG. 5). For example, an outermost region 114a (e.g., a first layer of three layers) of each pyramidal microstructure may have a lesser height than the remaining regions of the pyramidal microstructure, an intermediate region 114b (e.g., a second layer of three layers) of each pyramidal microstructure may have a greater height than the outermost region but a lesser height than an innermost region of the pyramidal microstructure, and the innermost/central region 114c (e.g., a third layer of three layers) of each pyramidal microstructure may have a greater height than the remaining regions of the pyramidal microstructure. Thereby, multi-layer pyramidal microstructures may be formed within the second electrode 112. In some embodiments, it is contemplated that the height of the outermost region 114a may be approximately one-third of the height of the innermost/central region 114c, and the height of the intermediate region 114b may be approximately two-thirds of the height of the innermost/central region 114c

[symbol]

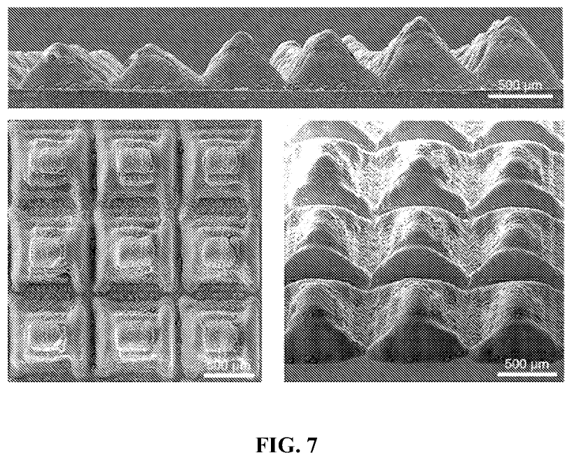

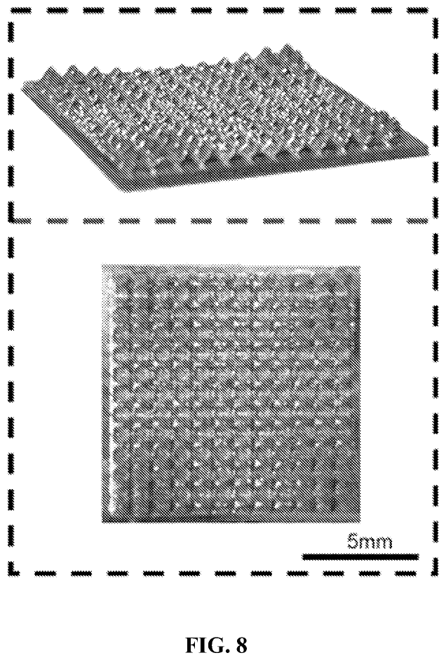

In some embodiments, the microstructures 114 may form a gradient array on the second electrode 112. In particular, the microstructures 114 may form regions of lesser or greater heights on the second electrode 112. For example, microstructures 114 in a first area encompassing the vertices/extremities of the second electrode 112 may have a greater height than the remaining microstructures of the second electrode 112. Additionally, microstructures 114 in a second area surrounding the first area of the second electrode 112 may have a lesser height than the microstructures 114 of the first area but a greater height than the remaining microstructures of the second electrode 112. Microstructures 114 of a third/remaining area of the second electrode 112 may have a lesser height than the microstructures 114 in the first and second areas. The plurality of microstructures 114 (e.g., pyramidal microstructures) with different heights in the gradient microstructures is demonstrated by the scanning electron microscopy (SEM) in (FIG. 7) and by the optical images (FIG. 8).

It is contemplated that the fine features/geometry of the microstructures 114, particularly pyramidal microstructures, may contribute to a sensor 100 with an ultralow detection limit and ultrahigh pressure resolution under a large preload.

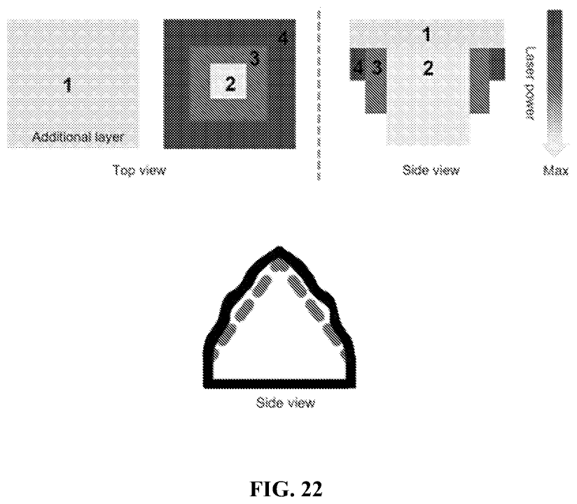

The second electrode 112 may further include a metal sputtering layer 116 formed on the microstructures 114. The metal of the metal sputtering layer 116 may be a material such as metals or nanocomposites with conductive fillers (e.g., metal or carbon nanoparticles or nanowires), and/or mixtures thereof. In some embodiments, the metal sputtering layer 116 is gold. In some embodiments, the second electrode 112 may further include an additional layer (see FIG. 22).

The dielectric layer 106 may include an ionic gel. It is contemplated that synergy between the array of microstructures 114 and the enhanced electric field from the ionic gel results in a low detection limit and high-pressure resolution under a high-pressure preload. It is further contemplated that the array of microstructures 114 and the ionic gel provide the sensor 100 with ultrahigh sensitivity over an ultra-broad sensing range.

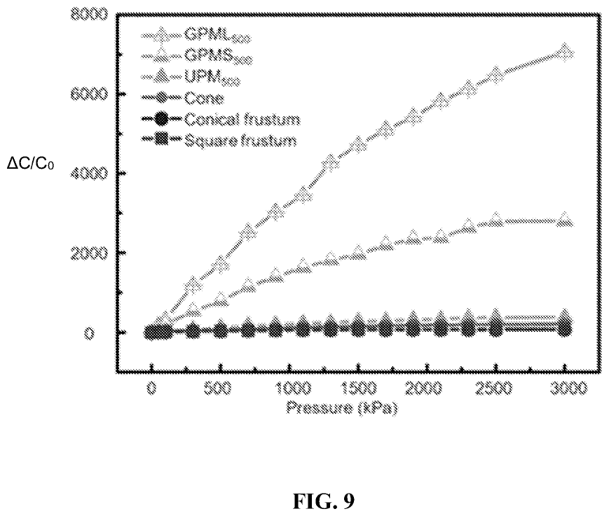

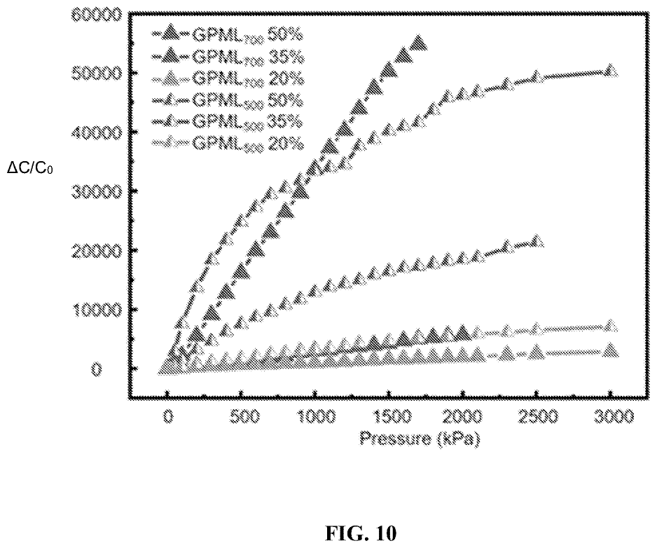

In application, it is contemplated that after an external voltage is applied to the sensor 100, electrons on the first electrode 108 and second electrode 112 may attract ions with opposite polarity in the dielectric layer 106 to aggregate at the electrode/ionic gel interfaces to form electron double layers. Numerous electron-ion pairs at the interface may be separated by nanometer distance and behave as micro/nanoscale capacitors with ultrahigh capacitance. The capacitance at the interface may be significantly increased as the second electrode 112 is deformed under pressure. The microstructures 114 can be sequentially deformed as a loading pressure increases, leading to a broad sensing range. In preferred embodiments, a gradient design as described above may also minimize the initial contact area (before pressure) at the second electrode/dielectric layer interface to result in a larger normalized contact area and capacitance change upon pressure loading. Therefore, the resulting sensor 100 may exhibit a much higher response than that with other microstructures (FIG. 9). Increasing the concentration of the ions in the ionic gel of the dielectric layer 106 may further enhance the electron double layer effect for increased pressure sensitivity, which can be combined with the microstructures 114 with properly designed profiles for the sensor 100 to achieve high sensitivity over the ultra-broad range (FIG. 10).

It is contemplated that sensor 100 has an even deformation as pressure is applied to the sensor 100. It is further contemplated that the profile and height of each microstructure 114 can be individually adjusted and optimized to provide an even deformation as the pressure increases.

The sensor 100 as described above has a high sensitivity. For example, the sensor 100 may have a sensitivity of 33.7 kPa⁻¹ over a linear range of 1700 kPa. The sensor 100 as described above may also have a low detection limit. For example, the sensor 100 may have a detection limit of 0.36 Pa. The sensor 100 as described above may also have a high linearity. For example, the sensor 100 may have a linearity of 0.99 over a linear range of 1700 kPa. The sensor 100 as described above may also have an excellent pressure resolution. For example, the sensor 100 may have a pressure resolution of 0.00725% (e.g., pressure variation of 145 Pa with a pressure preload of 2 MPa).

The sensor 100 as described above may have a rapid response time. For example, the sensor 100 may have a response time between 30-50 milliseconds. It is further contemplated that the sensor 100 may be stable and repeatable over cyclic loading under a pressure of 800 kPa., with nearly negligible drift in the sensor response over 4,500 cycles.

The flexible nature of the sensor 100 and its components (e.g., first electrode 108, substrate 110, second electrode 112, etc.) may allow the sensor 100 to attached to a surface of any structure or object, including a curved surface.

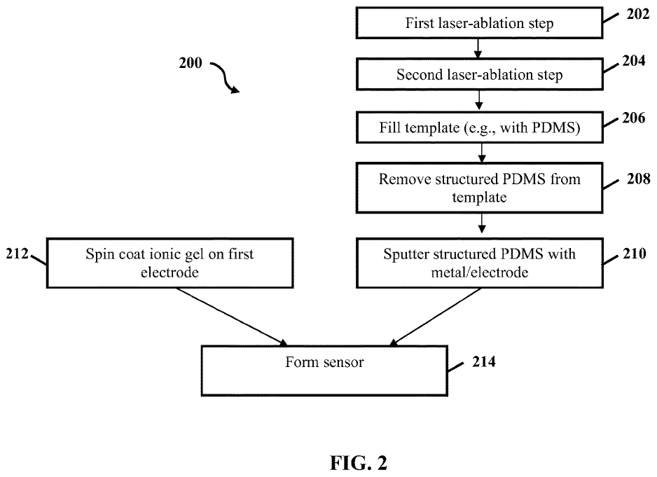

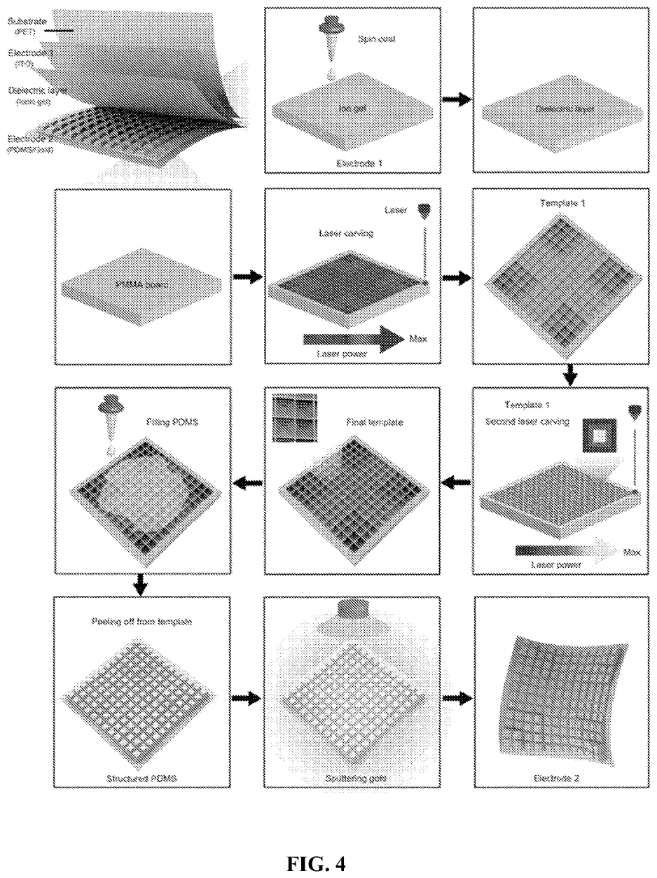

Embodiments further relate to methods of making the sensor 100. As seen in FIGS. 2 and 4, a method 200 may comprise a first laser-ablation step 202. Step 202 may include laser ablating a template to include a plurality, such as an array, of cell units within the template. It is contemplated that the laser is a CO₂ laser, preferably a CO₂ laser with a Gaussian beam profile. It is further contemplated that laser ablation may advantageously allow for high design flexibility to adjust the size, shape, height, density, etc. of cell units (and microstructures 114) in comparison to other fabrication methods for forming templates (e.g., photolithography, 3D printing, electrochemical oxidation, micro-engraving). The cell units may be any shape, though it is contemplated that the cell units may be cube shaped or substantially cube shaped. The template may be formed from any suitable material, such as a polymethyl methacrylate (PMMA) material. In preferred embodiments, a first area of the template encompassing the vertices of the template may be ablated with a high (or maximum) laser power, such that cell units in the first area may have a greater depth than the remaining cell units of the template. Additionally, a second area surrounding the first area of the template may be ablated with an intermediate laser power, such that cell units in the second area may have a lesser depth than the cell units of the first area but a greater depth than the remaining cell units of the template. The third area (e.g., remaining area) may be ablated with a low (or minimum) laser power and have a lesser depth than cell units in the first and second areas. It is contemplated that the laser powers described above may be relative to one another to form the gradient structures, and the values of the laser powers may be different and easily scaled up and down depending on a specific laser machine used.

The method 200 may further comprise a second laser-ablation step 204. Step 204 includes laser ablating each cell unit to include a pyramid shape. In particular, each cell unit may be ablated to include a plurality of layers of various depths such that a pyramid shape is formed. It is contemplated that the focus of the laser may be fixed to particular regions of each cell unit, and the power of the laser may be reduced from an outermost region to an innermost region to form the pyramid shape. For example, an outermost region of each cell unit may be ablated with a low (or minimum) laser power, such that the outermost region has a lesser depth than the remaining regions of the cell units. Additionally, an intermediate region of each cell unit may be ablated with an intermediate laser power, such that the intermediate region has a greater depth than the outermost region but a lesser depth than an innermost region of the cell unit. Finally, an innermost (e.g., central) region of each cell unit may be ablated with a high (or maximum) laser power, such that the innermost region has a greater depth than the remaining regions of the cell units. A final template is formed after step 204 is complete.

The method may further comprise a step 206 of filling the template formed from step 204 with a second electrode material (e.g., PDMS). After the second electrode material is cured, the second electrode material is removed from the template (step 208) to form a second electrode 112 of a bottom electrode layer 104. It is contemplated that the second electrode 112 includes a plurality of pyramidal microstructures 114 corresponding to the cell units ablated in the template. For example, due to laser-ablation strategy outlined above with respect to step 202, pyramidal microstructures 114 in a first area of the second electrode encompassing the vertices of the second electrode 112 may have a greater height than the remaining pyramidal microstructures 114 of the second electrode 112. Additionally, pyramidal microstructures 114 in a second area surrounding the first area of the second electrode 112 may have a lesser height than the pyramidal microstructures 114 of the first area but a greater height than the remaining pyramidal microstructures 114 of the second electrode 112. The microstructures 114 of the third area (e.g., remaining area) of the second electrode 112 may be have a lesser height than the pyramidal microstructures 114 in the first and second areas. Further, due to the laser-scribing strategy outlined above with respect to step 204, an outermost region of each pyramidal microstructure 114 may have a lesser height than the remaining regions of the pyramidal microstructure 114. Additionally, an intermediate region of each pyramidal microstructure 114 may have a greater height than the outermost region but a lesser height than an innermost region of the pyramidal microstructure 114. Finally, an innermost (e.g., central) region of each pyramidal microstructure 114 may have a greater height than the remaining regions of the pyramidal microstructure 114. Thereby, a gradient array of pyramidal microstructures 114 may be formed within the second electrode 112.

The second electrode may further be sputtered with metal (step 210).

The method may further comprise a step 212 of coating (e.g., spin coating) an ionic gel on a first electrode 108 of a top electrode layer 102, thereby forming a dielectric layer 106. Finally, the method may further comprise a step 214 of forming the sensor 100, such that the ionic gel is positioned between the first electrode 108 and the second electrode 112.

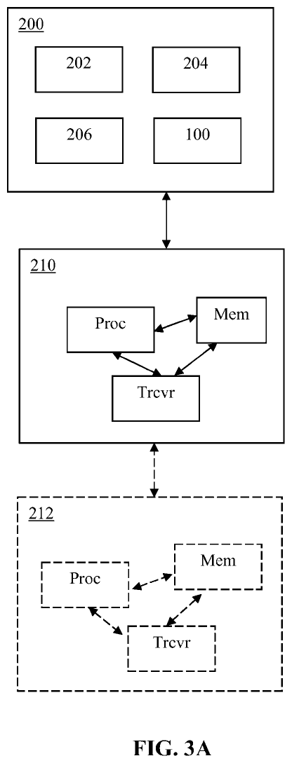

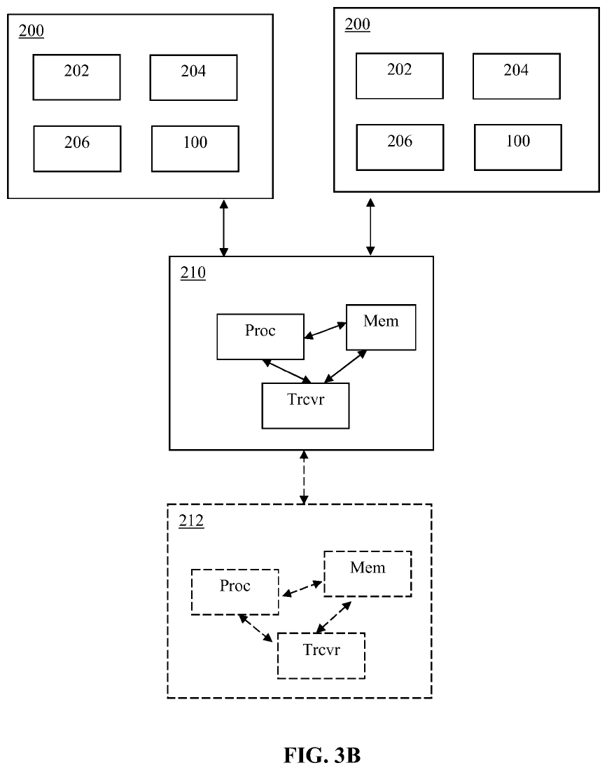

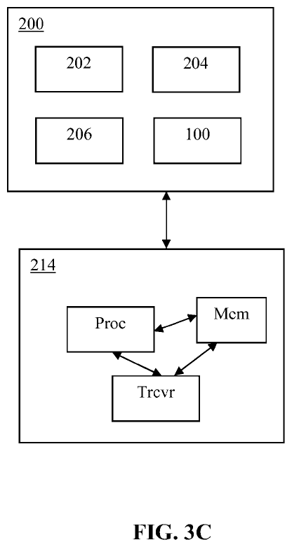

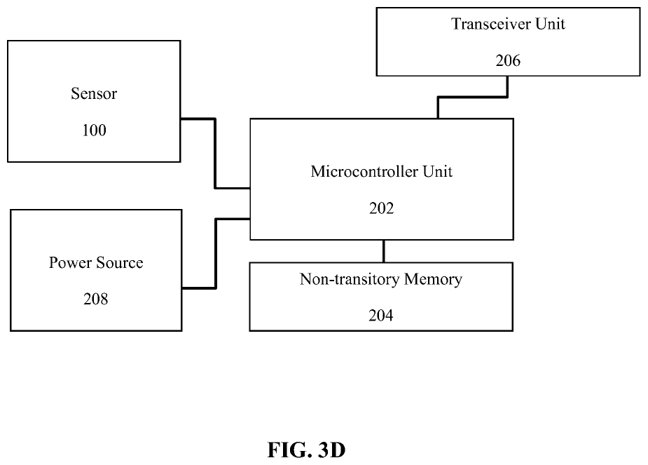

Embodiments of the apparatus can be configured to include at least one sensor 100, such as a plurality of sensors 100 and/or an array of sensors 100 (see FIG. 3B). It is contemplated that the sensor 100 as described herein may be used in a number of different applications, including but not limited to, health-monitoring devices, intelligent human-machine interfaces, and smart prosthetic interfaces. Ultimately, the disclosed sensor 100 and methods of making thereof can be leveraged to easily tune the sensor performance for carrying out any number of target applications.

As described above, the sensor 100 is configured to detect a change in capacitance that may then be translated into an electrical signal. In some embodiments, as seen in FIGS. 3A-3C, the apparatus can include at least one electronic device 200. Each electronic device 200 can include at least one sensor 100 incorporated therein. The electronic device 200 may include a plurality of electrical components, such as a microcontroller unit 202 that is connected to non-transitory memory 204 or other type of non-transitory computer readable medium and a transceiver unit 206 (e.g., Bluetooth transceiver unit). The microcontroller unit 202 interfaces with the rest of the components of the electronic device 200. The electronic device 200 may further include a power source 208 for powering the microcontroller unit 202 and electric components thereof. The power source 208 of the electronic device can be a battery, such as a rechargeable battery, configured to provide a source of voltage to power the electronic device 200 and the components of the electronic device 200.

The microcontroller unit 202 can receive data from the sensor 100 and store that data in its memory. The electronic device 200 can be configured to transmit the collected data to another device or evaluate the collected data to determine an output.

In some embodiments, as seen in FIG. 3C, the electronic device 200 may be configured to directly communicate with an external object 214 on which the sensor(s) 100 are attached to effectuate some response (for example, as described in more detail below, the microcontroller unit 202 may communicate with a robotic hand based on data provided by the sensors). In some embodiments, the microcontroller unit 202 may utilize a data driven model, such as an artificial intelligence model and/or a machine learning model, to aid in effectuate some response. It is contemplated that the model may be trained using collected data, such as data collected during testing and clinical trials.

Each sensor 100 or plurality of sensors 100 of an electronic device 200 can be communicatively connected to the microcontroller unit 202 and/or the non-transitory computer readable medium 204 such that the sensors 100 interface with and provide data to the microcontroller unit 202 and/or the non-transitory computer readable medium 204 (e.g., via a serial peripheral interface (SPI), an inter-integrated circuit (I2C), a universal asynchronous receiver-transmitter (UART), etc.). The microcontroller unit 202 can be a processor or other type of control hardware element.

In some embodiments, the microcontroller unit 202 can wirelessly transmit the data collected by the sensor 100 or plurality of sensors 100 to an input/output device 210 (e.g. a smart phone, tablet, laptop computer, personal computer, object 214, etc.) using the transceiver unit 206. While FIGS. 3A-3B are schematic block diagrams including one sensor 100 and two sensors 100, respectively, the disclosure encompass all embodiments with at least one sensor 100.

In some embodiments, the data collected by the sensor 100 or plurality of sensors 100 may be continuously streamed to the input/output device 210. It is contemplated that the electronic device may therefore provide real-time data collection. In other embodiments, the data collected by the sensor 100 or plurality of sensors 100 may be periodically streamed to the input/output device 210 (e.g., non-continuously at pre-determined intervals, every five seconds, every minute, etc.). The data collected by the sensor 100 or plurality of sensors 100 can also be stored within the non-transitory computer readable medium of the electronic device 210 for an extended period of time before being transmitted to the input/output device 210.

It should be appreciated that the input/output device 210 is a computer device that has at least one processor (Proc) connected to at least one non-transitory computer readable medium (e.g. memory, a hard drive, etc.) (Mem) and at least one transceiver unit (e.g. a network transceiver, etc.) (Trcvr).

It is contemplated that the data may alternatively or subsequently be sent to a central computer device 212 (e.g. server, an operator workstation, etc.) that can be connected to the input/output device 210 (e.g. via a network connection and application programming interface (API) the central computer device may have with the input/output device 210 running the application, etc.). The central computer device 212 may be configured to store the data of each electronic device 200 and/or sensor 100 it receives. The forwarding of such data can be provided via a communication connection the electronic device 200 directly has with an input/output device 210 such that data is sent to the central computer device 212 via the input/output device 210.

It should be appreciated that the central computer device 212 can be configured as a computer device that has at least one processor (Proc) connected to at least one non-transitory computer readable medium (e.g. memory, a hard drive, etc.) (Mem) and at least one transceiver unit (e.g. a network transceiver, etc.) (Trcvr). The central computer device 212 can be configured as a database server, a workstation, a desktop personal computer, a laptop computer, or other suitable computer device that can receive the sensor data and evaluate the sensor data for generation of an output that can be displayed or otherwise output to an operator.

It is contemplated that once the data is transmitted to the input/output device 210 and/or the central computer device 212, data collected by the sensor(s) 100 may be analyzed and evaluated. For example, the data can be processed using artificial intelligence or machine learning algorithms stored on the input/output device 210 and/or the central computer device 212. In particular, the input/output device 210 and/or central computer device 212 may run a program that uses the collected data along with a module trained via a machine learning process that received the collected data and processes that data to determine an output.

In some embodiments, the input/output device 210 and/or the central computer device 212 can be configured to generate a graphical user interface (GUI) on a display for providing information to a user regarding collected data. For example, the electronic device 200 may transmit data collected from the sensor 100 or plurality of sensors 100 the input/output device 210 and/or the central computer device 212, and the collected data may be displayed in the form of a graph, chart, text, or other display via the GUI. The GUI may further display outputs or other collected data to the user.

In yet other embodiments, it is contemplated that the sensor(s) 100 can be integrated into an electronic device 200 that can have sufficient processing power and input devices and output devices for analyzing the sensor data collected via the sensor(s) 100. In such a configuration, the electronic device can include code defined in its memory and run that code to evaluate the data in accordance with a pre-defined evaluation process for generation of output to a user. Such output can be displayed via a GUI that can be generated on a display of the electronic device 200.

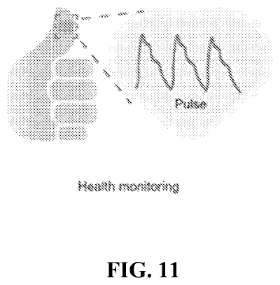

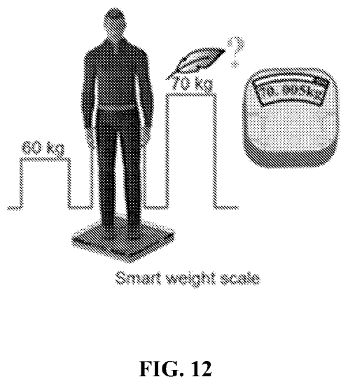

In one exemplary application, the sensor 100 or a plurality of sensors 100 may be used for subtle pulse detection (FIG. 11). Due to its low detection limit and high-pressure resolution, the sensor 100 may be configured to subtle pulses from the fingertip. In another exemplary application, the sensor 100 or a plurality of sensors 100 may be used in a high-resolution smart weight scale or chair (FIG. 12).

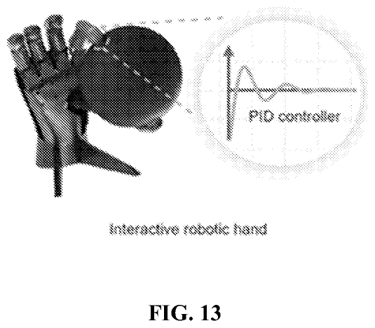

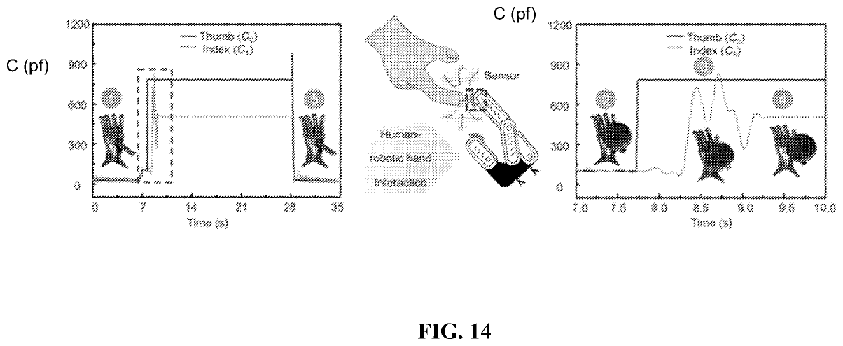

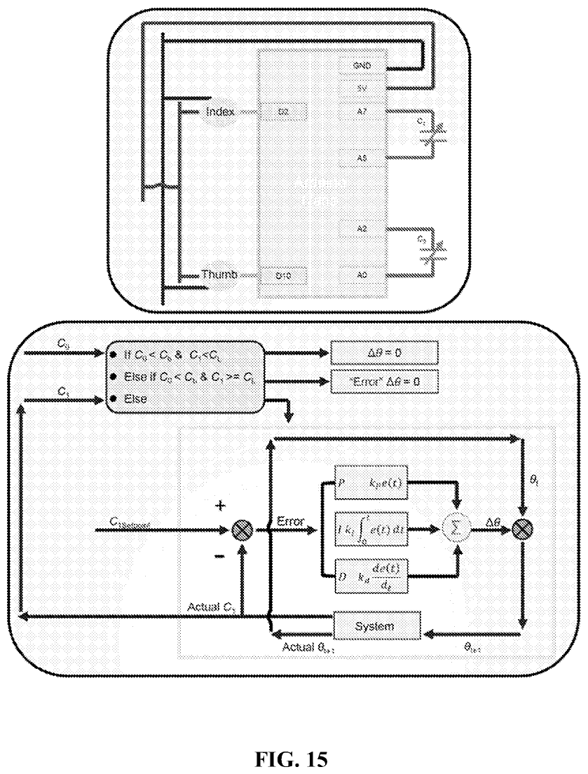

In another exemplary application, the sensor 100 or plurality of sensors 100 may be used with an interactive robot hand or with a smart prosthetic interface (FIG. 13). In particular, a plurality of sensors 100 may be attached on a plurality of fingers of a robotic hand (e.g., one sensor per finger). For example, one sensor 100 may be attached on the thumb of a robotic hand and another sensor 100 may be attached on the index finger of the robotic hand. A first sensor 100 may be configured to detect an object and a second sensor 100 may be configured to grab the object with a suitable force (FIG. 14). Actuated by the rotation (θ) of servo motors placed at the end of the finger joints, the fingers change vertical displacement due to the kinematic constraint to move the robotic hand (FIG. 15). The dexterous manipulation of delicate objects with the robotic hand is achieved by using a proportion-integration-differentiation (PID) controller (e.g., see microcontroller in FIGS. 3A-3D), with the flow chart shown in FIG. 15. For instance, the PID controller can include (1) a proportional controller configured to adjust dexterous movements in direct proportion to capacitance measurements from the sensor 100; (2) an integral controller configured to ensure that the control output aligns with a desired set-point; and (3) a derivative controller providing closed loop stability and enabling a faster ascent to a target while minimizing overshooting.

In operation, a threshold value (C_{b}) for the target operation prevents accidental trigger (e.g., variation/vibration in the environment) of the robotic hand (FIG. 14, stage 1). After gently placing an object on the thumb, the capacitance (C₀) of the sensor on the thumb instantly increases upon contact to exceed the preset C_{b} (stage 2). As a result, the system identifies the object and initiates the operation of the PID controller to move the index downward for grabbing. The desired capacitance value of the sensor on the index finger can be determined or measured as C₁ₛₑₜₚₒᵢₙₜ for the target operation such as handling objects. The difference between the actual measured capacitance value C₁ from the sensor on the index finger and C₁ₛₑₜₚₒᵢₙₜ allows the PID controller to calculate the needed rotation output (Δθ) in the motor to drive the index finger. The iterative process is revealed by the measured fluctuations in the C₁ values around C₁ₛₑₜₚₒᵢₙₜ (stage 3). After completion of the movement based on the feedback closed-loop control (<1 s), the balloon is gently grabbed between the thumb and index fingers with a suitable force (stage 4). Release of the balloon from the robotic hand is then triggered by vertically pinching the object with a human hand, which reduces the object/sensor contact to a lower sensor response (either C₁ or C₀) than the preset threshold (stage 5).

### EXAMPLES

Exemplary sensors were constructed according to the disclosure provided herein. Experiments were conducted on the exemplary sensors, the methods and results of which are discussed below. Comparative sensors were also constructed and subject to experiments.

### Methods—Preparation of PMMA Mold

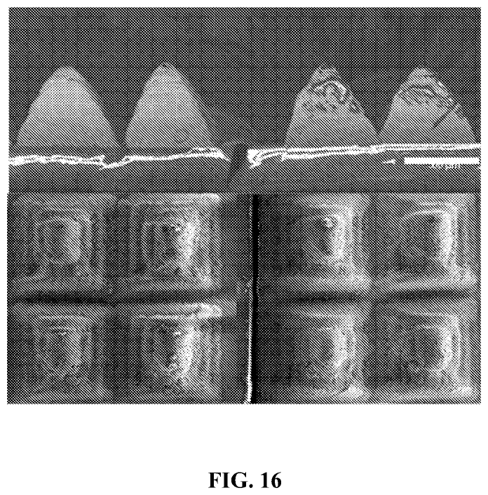

The PMMA mold was created by laser scribing with the CO₂ laser (VLS 2.30 universal laser system (30 W, wavelength of 10.6 μm, Inc. VLS2.3) under ambient conditions with patterns created in Inkscape. The gradient structure was fabricated using raster mode with 20% of the maximum speed, varying power between 0-30% of the maximum power, 1000 PPI, and an image density of 6. The gradient base of the microstructures with a reduced height from outside to inside was first formed by gradually decreasing laser power from the black to red and then to the purple region (FIG. 4). Next, the reduced laser power was used in the subsequent laser processing step at the same location to form pyramidal structures. The comparison between microstructures obtained from two PMMA templates that were separately created by using the same laser parameters demonstrated the reasonably good consistency of laser fabrication (FIG. 16).

### Methods—Preparation of Second Electrode

A mixed base and curing agent of Sylgard 184 with a weight ratio of 10:1 was spin coated onto the PMMA mold at a speed of 400 rpm to obtain a uniform layer with a thickness of ca. 250 mm. After degassing and curing in the oven at 90° C. for 1 h, slowly peeling the cured PDMS layer off from the PMMA mold was followed by air plasma (PDC-001-HP, Harrick Plasma) treatment at 30 W for 10 min. Next, the PDMS layer was dipped in the APTES solution (concentration of 15 mM with 35.1 μL in 10 mL DI water) for 12 h to achieve strong adhesion followed by sputtering of 50 nm-thick Au (Quorum Q150R, Sputter Coater) as the bottom electrode.

### Methods—Preparation of First Electrode and Dielectric Layer

After preparing acetone and PVDF-HFP with a mass ratio of 20:3, the ionic gel [EMI][TFSI] was added with a mass ratio of 20%, 35%, or 50% of PVDF-HFP to obtain the mixture. The mixture was heated and stirred at 120° C. and 1000 rpm until PVDF-HFP was completely dissolved to obtain the uniform solution. The solution was then spin-coated on the as-received ITO/PET film (cut to 1.2 cm×1.2 cm) at 1000 rpm for 30 s and dried on the hot plate at 80° C. in a fume hood to fully evaporate the acetone and cure the iontronic layer.

### Methods—Pressure Sensor Assembly

A transparent medical tape (3M, Tegaderm™ film) was used at the edge between the bottom and top electrodes to assemble the pressure sensor and also used to tightly attach the sensor to the finger for pulse detection at the fingertip. Four pressure sensors sandwiched between two PMMA boards (1.5 cm×1.5 cm×0.1 cm) were placed under each leg of the chair for weight measurements and demonstrations of high-pressure resolution.

### Characterization and Measurement

The surface morphology of the bottom electrode was characterized by field emission-scanning electron microscopy (Zeiss FESEM Gemini 500). The capacitance of the pressure sensor (10 mm×10 mm) was measured by an LCR meter (Hioki IM3536) at a frequency of 1 kHz, unless specified otherwise. A force gauge (HLB Test Stand+HP-500N, Mxmoonfree Co., Ltd) was used to apply and record the pressure. Signals from two capacitors for robotic hand application were measured by the Arduino nano board⁶⁹. The repeatability test was performed by using a linear rail guide slide actuator. Areal capacitances were measured by sandwiching the ionic gel between two flat PET/ITO electrodes. Smoothening of the noisy data was achieved by applying an FFT filter with 5 points of window in Origin.

### Finite Element Analysis (FEA)

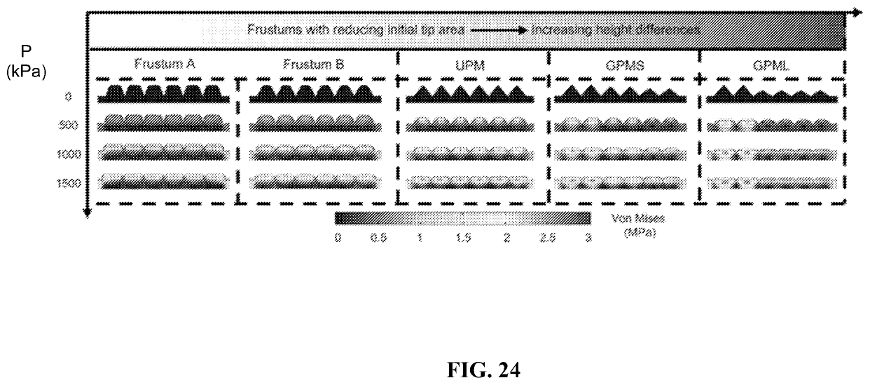

The mechanical and electrical FEA was performed using the commercial package COMSOL Multiphysics 5.6. In the mechanical simulation, the structured bottom PDMS electrode was modeled as an incompressible Mooney-Rivlin material, with Young's modulus of 750 kPa and Poisson's ratio of 0.49. A pressure of 1600 kPa was applied on the top electrode that was treated as a rigid plate (not shown in FIG. 24). The initial electrode/dielectric contact interface (A₀) is determined at the pressure of 5 kPa. In the coupled EDL and mechanical simulation, the distribution of the electric field in the iontronic layer was obtained by applying pressure and an electric potential of 3 V on the top ITO electrode and grounding the bottom gold. After merging PVDF and KOH as the iontronic medium with a diffusion coefficient of 1 e⁻⁹ m²/s, the initial relative concentration of the iontronic medium was set to 0 for computational efficiency without the loss of generality. The concentration of the iontronic layer at the gold boundary was set as Con mol/m³ with respect to the initial concentration. The electric field distribution was computed by coupling mechanical, electrostatics, and transport of dilute species modules (Supplementary Note 3). The transport of dilute species was driven by the generated electric field from the applied potential on the top electrode and the generated polarization field due to the pressure applied on piezoelectric PVDF. On the other hand, the transport of the diluted species generated an electric field due to the space charge density coupling. Increasing the pressure and concentration at the ITO electrode resulted in the increased electric field distribution, which further facilitated the transport of the ions in the iontronic medium. It is worth noting that time-varying pressure may contribute to a time-varying electric displacement field, which may result in time-varying free surface charge density for an increased rate of transport of ions.

### Results—Gradient Pyramidal Microstructures From Laser-Ablated Molds

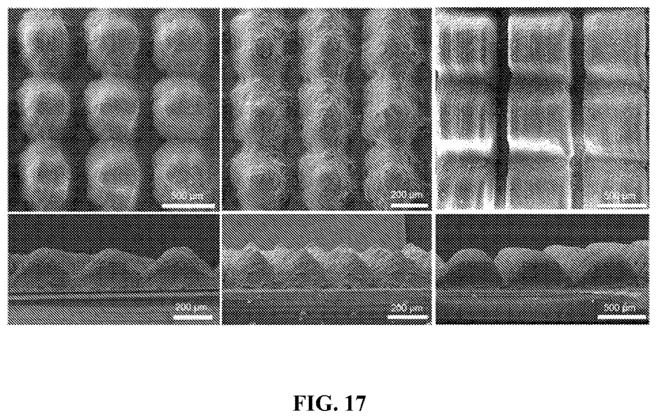

A one-step thermal decomposition and volatilization process of PMMA transforms it from solid to volatiles, which results from the C—O bond cleavage reaction, [CH₂C(CH₃)(CO₂CH₃)]n→CO+CO₂+H₂O+H₂. With a rectangular-gaussian laser power intensity distribution that is sufficient to ablate PMMA, the profile of the laser-ablated holes appears to be Gaussian. With different programmed laser patterns, representative microstructures that are commonly used in pressure sensors can be easily fabricated, including conical frustums, cones, and square frustums (FIG. 17). Compared with the circular laser patterns, the square laser patterns can create square frustum microstructures with high consistency.

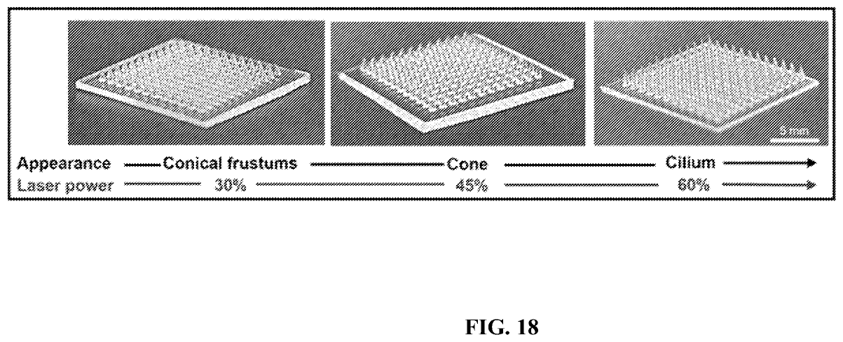

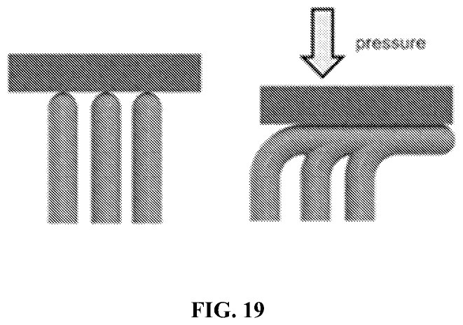

As progressive deformation of the microstructures upon increasing pressure load can ensure high sensitivity over a wide sensing range, it is highly desirable to explore gradient microstructures. Careful design of the gradient can also give high linearity in the entire sensing range. However, fabrication is traditionally challenging even with complex photolithographic processes. Fortunately, the laser ablation of PMMA with the gaussian distributed laser beam provides a simple yet viable solution to overcome this challenge. Manipulating the laser power represents the most intuitive way to control the structure height for obtaining gradient microstructures. Indeed, the continuously increased maximum power of the laser creates taller and slimmer microstructures (FIG. 18), but their high aspect ratio makes them susceptible to bulking upon pressure loading (FIG. 19). As a result, the nonlinear deformation from buckling compromises the sensor performance in terms of linearity.

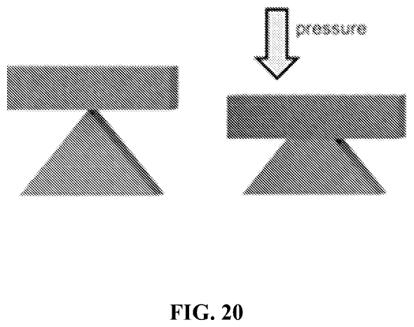

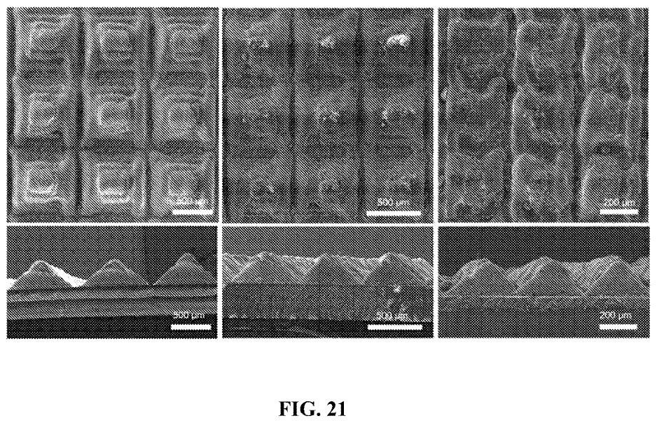

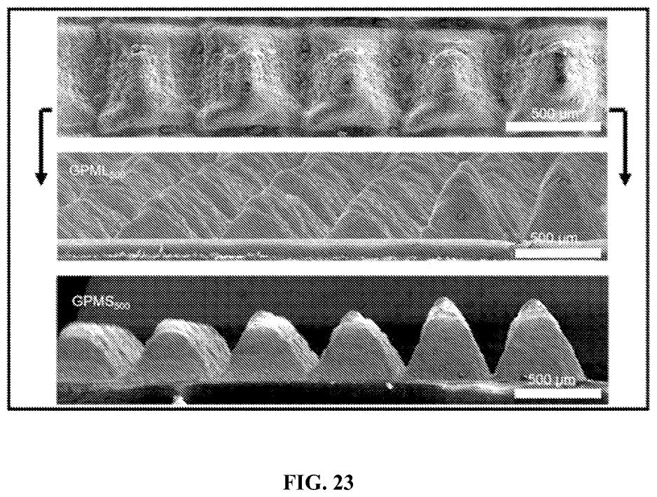

To address this issue, the multi-layered gradient pyramidal microstructures have been created by using multiple laser ablations, in which the successive laser ablation exhibits lower energy but wider distribution compared with the previous ablation. The realization of pyramidal microstructures can be simply achieved by fixing the focus of the laser beam and reducing power from inside to outside of each pattern unit. The multi-layered microstructures with the same cross-sectional area are susceptible to bulking upon pressure loading (FIG. 20), so it is highly desirable to create those with a gradually reduced cross-sectional area. To achieve this, decreased laser power is accompanied by simultaneously increased square laser pattern in each successive layer for fabricating the tri-layered PMMA template and corresponding PMDS pyramidal microstructure (FIG. 5). The pyramid-like microstructure with more accurate features is possible to achieve with an increased number of laser ablation layers. By modulating the sizes of the laser pattern while maintaining the ratio among three layers, different sizes of pyramidal microstructures can be formed (FIG. 21). Different heights in the resulting pyramidal microstructure can also be achieved by including an additional layer created from varying powers before laser ablating the tri-layered structures in the PMMA template (FIG. 22). The microstructures in different layers can exhibit hierarchically similar features (FIG. 23).

### Results—Sensing Performance of Different Laser-Induced Structures

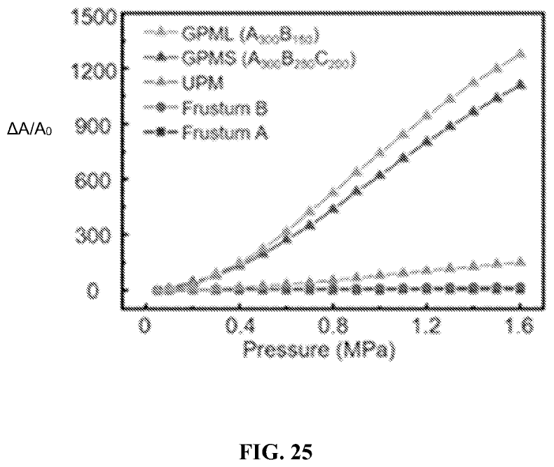

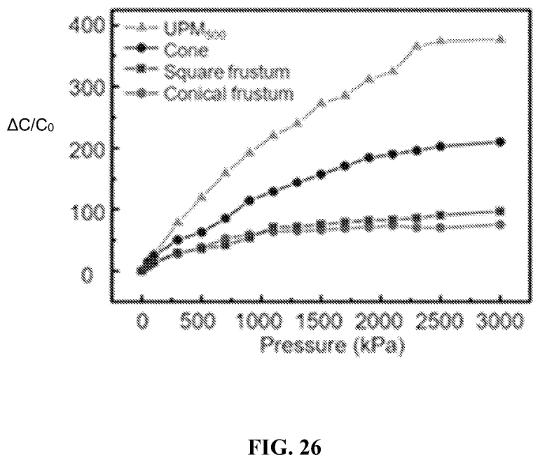

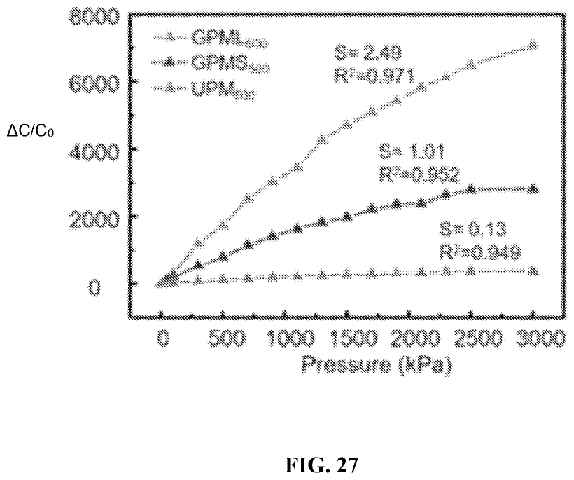

The deformation of the different microstructures upon pressure loading is first investigated by two-dimension (2D) finite element analysis (FEA) (FIG. 24). The pressure-induced capacitance change in the EDL-based capacitive sensor mainly comes from the changes in the contact area (ΔA/A₀) at the electrode/dielectric interface. The change in the relative contact area or capacitance from the uniform microstructures with the same heights under increasing pressure indicates the highest sensitivity in the sensor with pyramidal structures due to the smallest tip area. Different from the UPM, the GPM is progressively compressed from the tall to the short ones as the pressure increases, resulting in the gradually increased contact area at the electrode/dielectric interface. The initially smaller contact area of the GPM contributes to larger changes and higher sensitivity (defined as the relative capacitance change ΔC/C₀over the applied pressure P) compared with the UPM under the same applied pressure. Additionally, the GPM with a larger height difference (e.g., GPML with 150 μm difference in A₃₀₀B₁₅₀) shows slightly higher sensitivity than that with a small height difference (e.g., GPMS with 50 μm difference in A₃₀₀B₂₅₀C₂₀₀) (FIG. 25). The design insights and predictions from the FEA are validated by the experimental results with microstructures created from the laser-ablated PMMA molds. Compared with cone-and frustum-like microstructures, the pyramidal microstructure with a smaller tip area provides the sensor with the largest changes in the relative contact area and then capacitance upon pressure loading (FIG. 26). Moreover, the GPML exhibits higher sensitivity than that of UPM and GPMS (FIG. 27). As a result, the high sensitivity (S=(ΔC/C₀)/P) of 2.49 kPa⁻¹ can be obtained in the GPML over an ultrawide range of 3000 kPa (R²=0.97).

### Results—Sensing Performance Modulated by the Enhanced EDL Effect

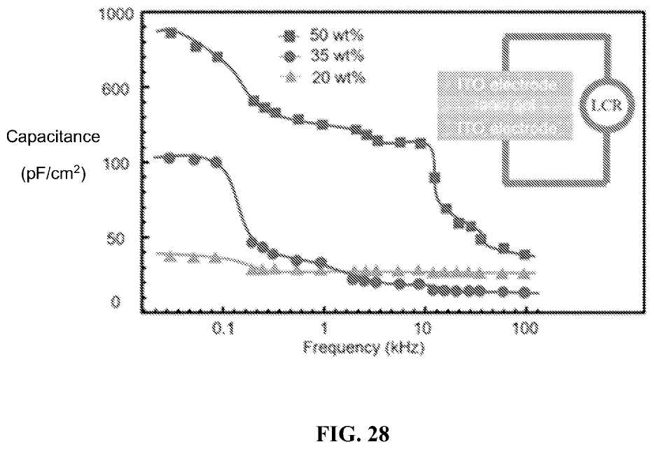

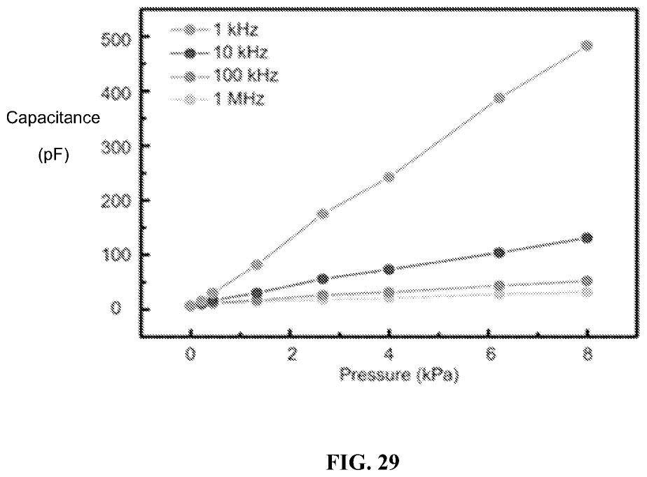

Modulation of the sensing performance can be easily achieved by increasing the concentration (20 wt %, 35 wt %, and 50 wt %) of the IL in the dielectric layer for an enhanced EDL effect. Increasing the IL concentration from 20 to 50 wt % results in an increased areal capacitance from 36.5 to 984 pF cm⁻² at 100 Hz (FIG. 28). The capacitive measurements at lower frequencies (e.g., <1 kHz) are less stable than those at higher frequencies. Additionally, the rotation speed of the IL molecule at high frequencies becomes slower to give smaller capacitance and capacitance changes upon pressure loading. Therefore, the optimized measurement frequency of 1 kHz is chosen in the following studies unless specified otherwise (FIG. 29).

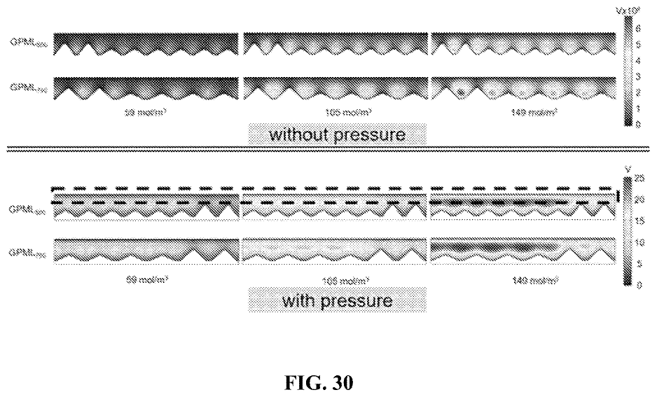

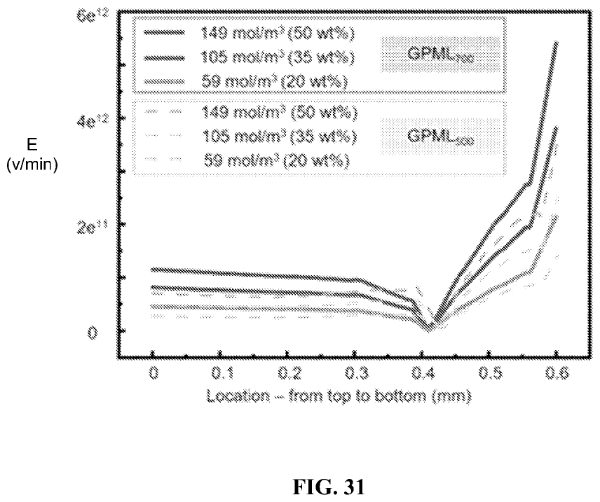

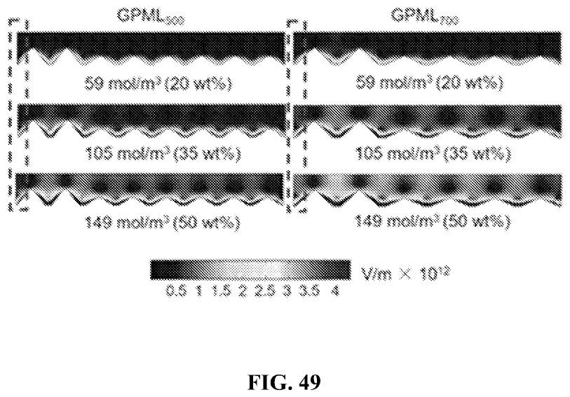

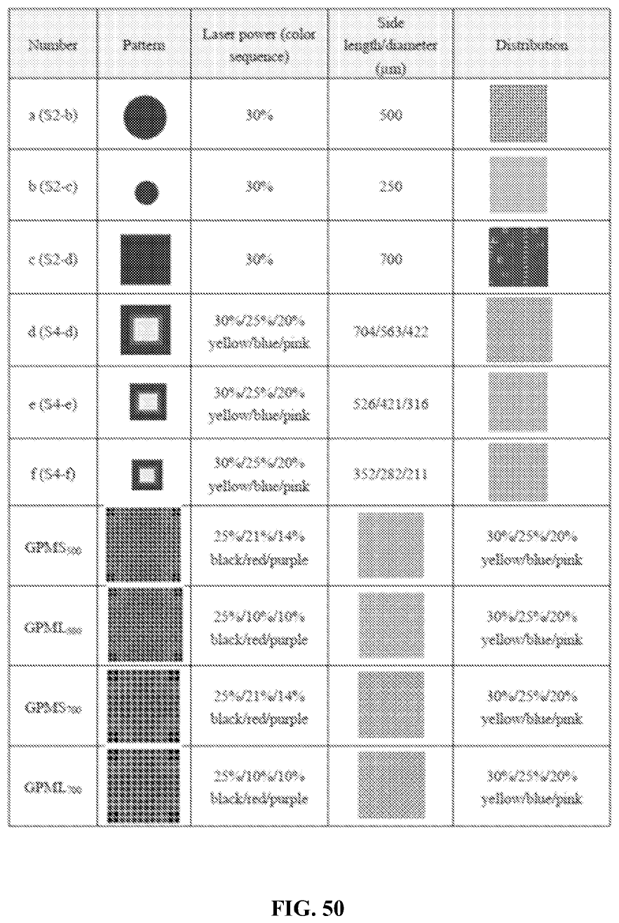

The enhanced EDL effect can be revealed by the electric field (FIG. 49) between the top electrode and microstructured bottom electrode as the molarity of IL increases from 59 to 105 and then to 149 mol/m³. Solving the Poisson, Nernst-Planck, and Butler-Volmer equations using COMSOL predicts a nonuniform potential distribution in the EDL domain (FIG. 30), resulting in a nonlinear electric field distribution (FIG. 31). The nonlinearity of the electric field is also enhanced by the increased IL concentrations. The capacitance of the sensor increases because of the changes in the contact area from the mechanical deformation of pyramids under compression. However, as the pressure increases, the deformation of the pyramid gradually decreases to degrade the capacitance change rate and decrease the sensitivity. This issue can be effectively remedied by a stronger electric field at the later compression stage (with higher pressure loading) for increased capacitance, resulting in good linearity over the whole sensing range (FIG. 30). With the increased IL concentrations, the electric field is further enhanced to form the EDLs at the electrode/IL interface even if the two are not directly in contact. However, further enhanced IL concentrations do not give an enhanced electric field upon higher pressure loading, resulting in increased sensitivity but decreased linear sensing range of the sensor.

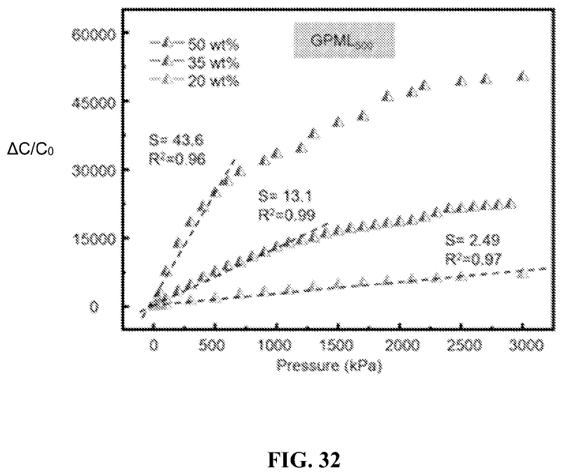

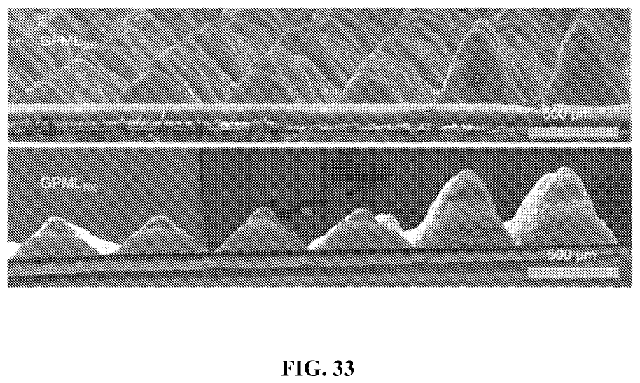

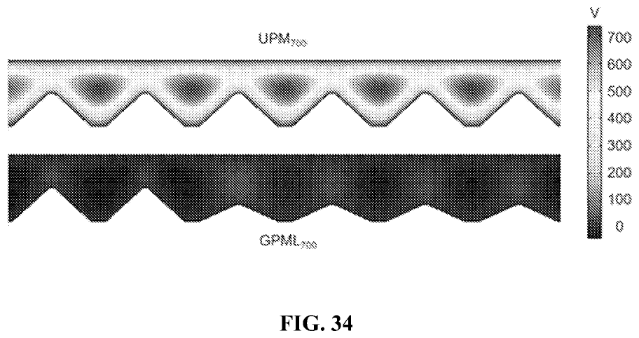

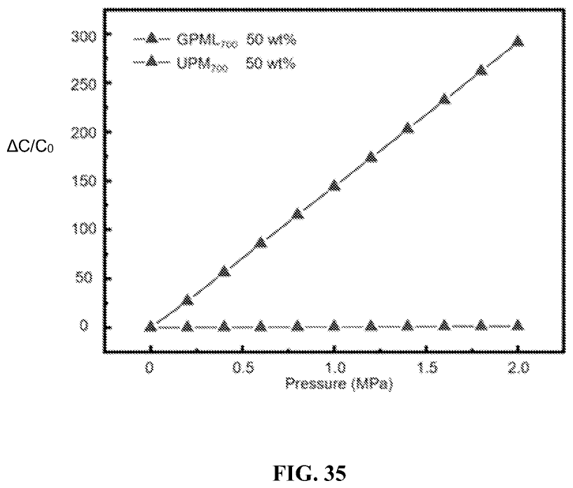

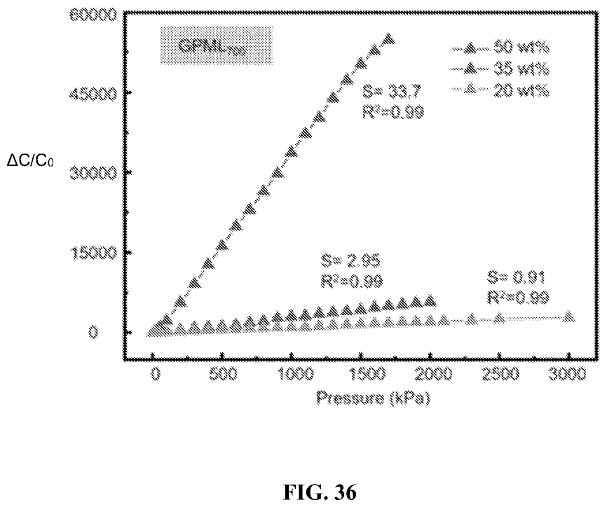

The insights obtained from the simulation on the influence of the IL concentration are leveraged to optimize the performance of the iontronic pressure sensor in the experiment. Increasing the IL concentration in GPML₅₀₀ from 20 to 35 and then to 50 wt % leads to an increase of sensitivity from 2.49 to 13.1 and then to 43.6 kPa⁻¹. However, the linear sensing range is reduced from 3000 to 1200 and then to 700 kPa (FIG. 32). Interestingly, the balance between the sensitivity and linear sensing range can be effectively overcome by careful design of the unit cell in the GPM. For instance, increasing the base size of the unit cell from 500 to 700 mm results in a stronger electric field with higher nonlinear changes in GPML₇₀₀ (FIG. 33). The much larger electric field change helps compensate for the slower increase of the capacitance at the later compression stage (higher pressure loading) to maintain linear capacitance changes. As a result, the increased sensitivity does not come at a cost of a considerably reduced linear sensing range compared with the uniform structure (FIGS. 34-35). As the IL concentration increases from 20 to 35 and then to 50 wt %, the sensing performance changes from 0.91 kPa⁻¹ over 3000 kPa to 2.95 kPa⁻¹ over 2000 kPa and then to 33.7 kPa⁻¹ over 1700 kPa (FIG. 36). The iontronic capacitive pressure sensor with high sensitivity over ultra-broad linear sensing range compares favorably with the previous literature reports.

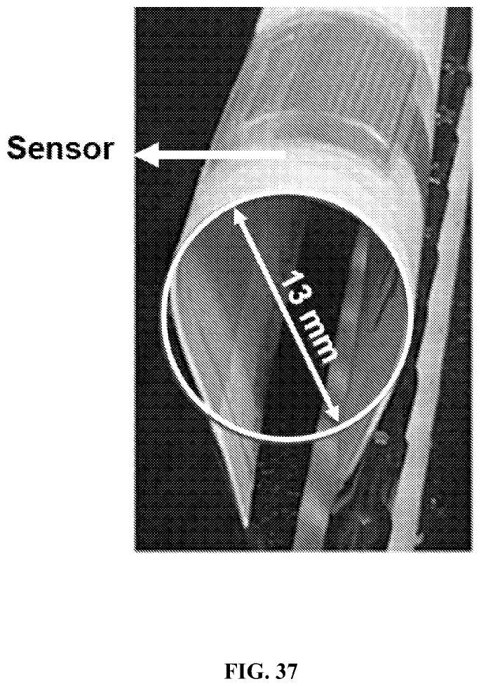

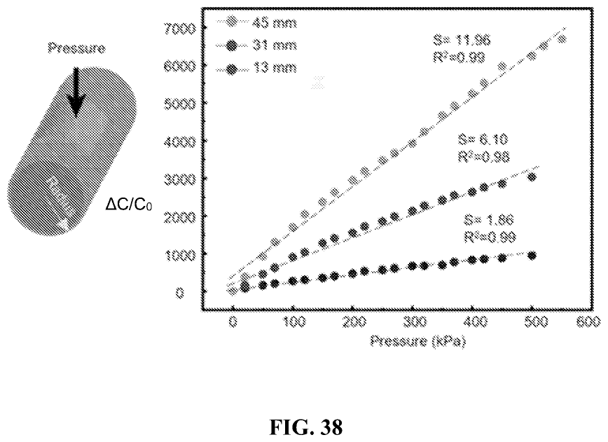

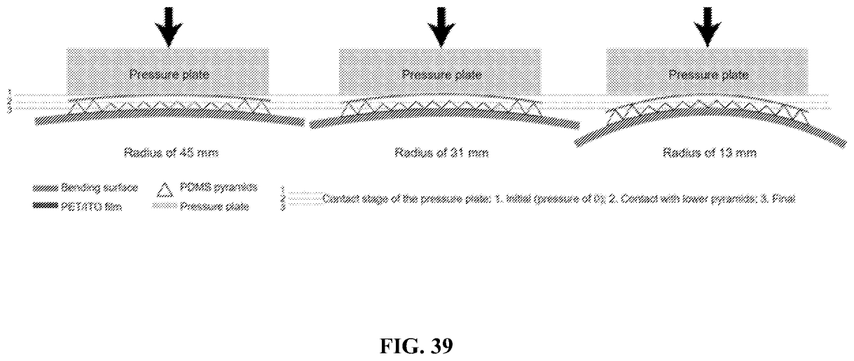

The flexibility of the sensor allows it to easily attach to a curved surface (FIG. 37). The enhanced performance of the pressure sensor (e.g., high sensitivity and linearity) usually benefits from innovative structure designs. However, the sensor performance is significantly reduced under bending conditions likely due to the change in the microstructures. As the bending radius is decreased from 45 to 31 and then to 13 mm, the sensitivity of GPML₇₀₀ decreases from 11.96 to 6.10 and then to 1.86 kPa⁻¹ (FIG. 38). This decrease results from the increased initial contact area and the reduced gap between the structured bottom electrode and the dielectric layer, increasing the initial capacitance (before pressure loading). The increased initial capacitance reduces the capacitance changes of the sensor under pressure and thus the sensitivity. Additionally, the non-uniform contact to the gradient pyramids upon bending reduces the sensing range from 1700 kPa to ca. 500 kPa (FIG. 39). However, the iontronic pressure sensor still exhibits reasonably good sensitivity in a relatively large linear sensing range due to the small initial contact area and gradually increased contact area with the increasing pressure. Further improvement can be possible when the iontronic pressure sensor is directly fabricated on the 3D freeform surfaces with a modified laser setup.

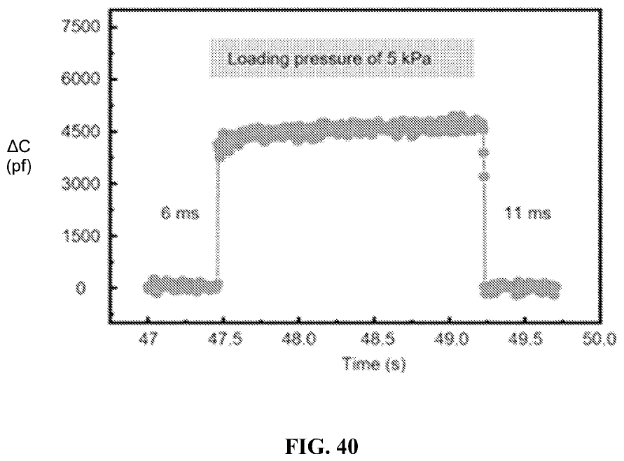

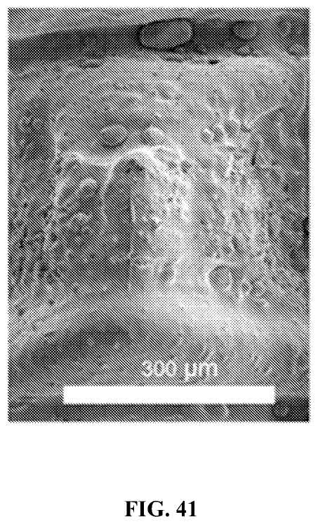

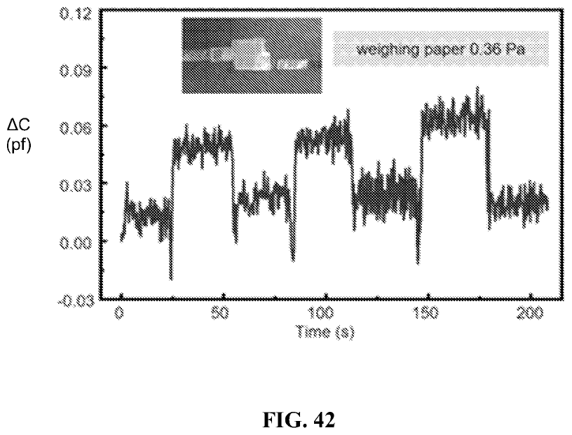

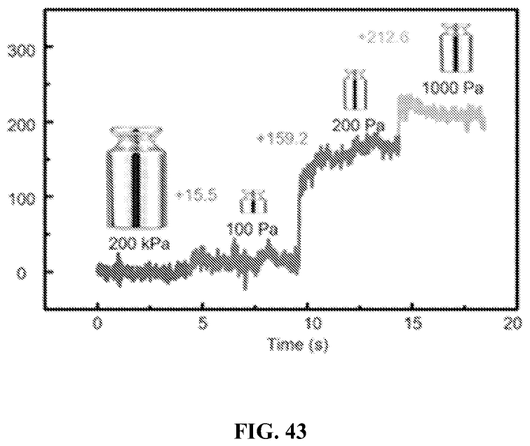

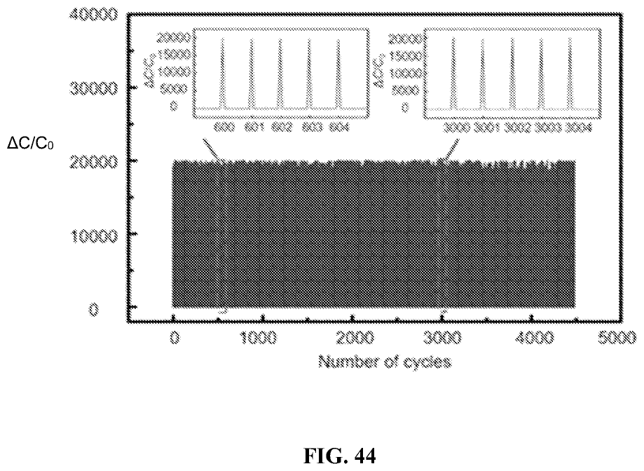

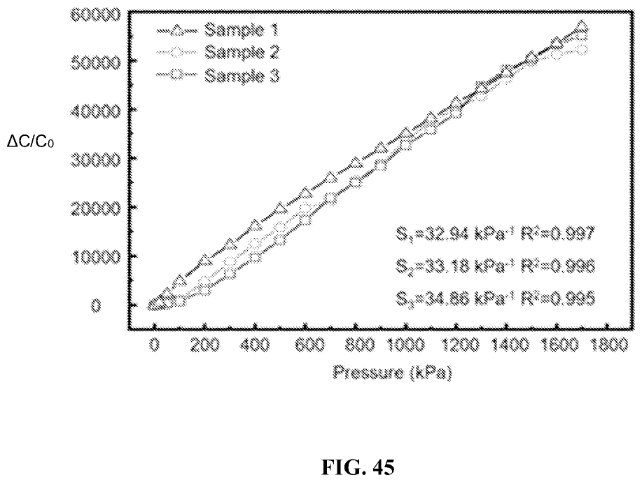

Besides the high sensitivity over the ultrabroad pressure range, the sensor with the gradient microstructures also exhibits a fast response/recovery of 6/11 ms from a pressure loading of 5 kPa (FIG. 40). The rapid response/recovery time is better than the existing piezoresistive, capacitive, and piezoelectric pressure sensors, and the biological skin with a response time of 30-50 ms. The initially small contact area at the fine tip of the pyramid created from the laser-ablated rough surface (FIG. 41) further provides the iontronic pressure sensor with a low detection limit of 0.36 Pa to detect a light weighing paper (FIG. 42). Additionally, the capability to detect small pressure changes under high pressure (denoted as pressure resolution) is vitally important in practical applications. Even after a high pressure of 200 kPa (from a weight of 2 kg) is applied, the additional small pressure of 100 Pa, 200 Pa, and 1 kPa from a weight of 1 g, 2 g, and 10 g sequentially applied on the sensor can still be successfully captured (FIG. 43) to give an ultrahigh pressure resolution. The sensor response is stable and repeatable over cyclic loading at a pressure of 800 kPa (FIG. 44), with almost negligible drift in the sensor response over 4,500 cycles. The batch-to-batch variation in the sensor response is also small with a relative standard deviation (RSD) of 3.11% from three different samples (FIG. 45), due to the highly reliable fabrication process.

### Results—Detections of Static and Dynamic Subtle Motions

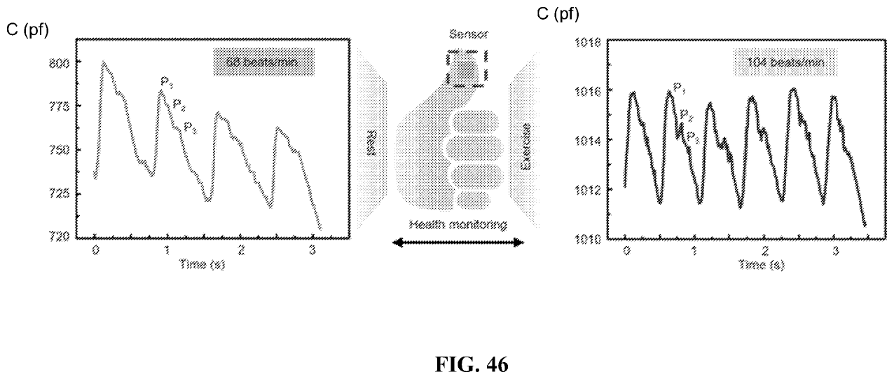

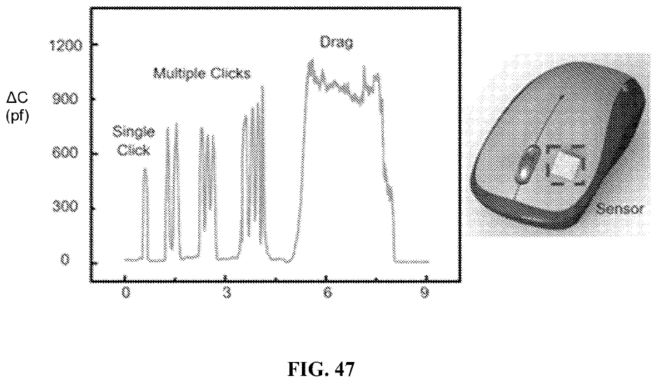

The flexible iontronic capacitive pressure sensor capable of detecting tiny pressures and subtle motions can be applied to monitor physiological signals from unconventional locations. Besides the commonly demonstrated pulse measurements from the jugular vein or wrist artery, the far weaker pulse signal from the fingertip (ca. 10 Pa) can be detected with a clear characteristic P-, T-, and D-waves by our iontronic pressure sensor (FIG. 46). The heart rate is increased from 68 to 104 beats per minute, as the healthy human subject (28 yr, female) transitions from resting to exercise (FIG. 46). Besides the convex surface to allow stable signal detection during motion^{43,51}, the fingertip pulse can also be easily accessed from smart Internet-of-Things or during human-machine collaborations. Attaching the sensor to a mouse with a double-sided tape measures actions from the single/double/triple clicks and hold-and-drag, demonstrating the reliability and stability over both static and dynamic pressure (FIG. 47).

### Results—High Pressure Resolution Under Large Pressure Loads

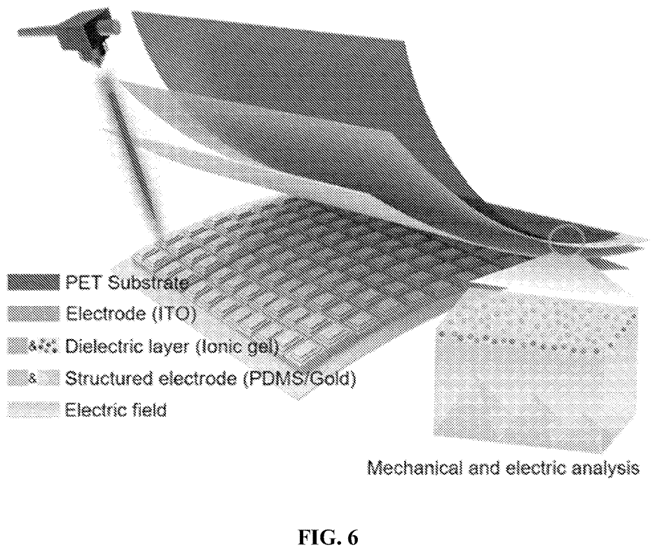

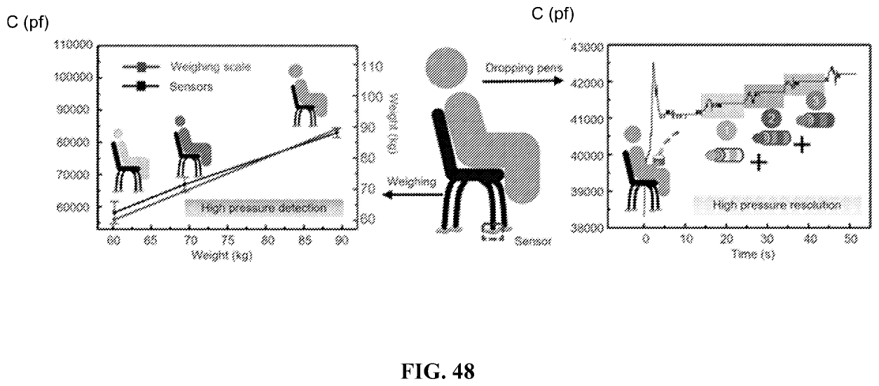

The drastically reduced (or saturated) sensitivity of most microstructured pressure sensors beyond 100 kPa limits their use to low pressure applications. Additionally, the low limit of detection often comes at a cost of a narrow sensing range and the tiny pressure detection is also only possible at nearly vanishing pressure preload (i.e., low pressure resolution). The GPM with fine features on the pyramidal surface in our iontronic pressure sensor allows it to detect tiny pressure under heavy load (or high pressure) to achieve ultrahigh pressure resolution. The representative proof-of-concept demonstration involves the use of a smart chair with four sensors (encapsulated by PMMA) placed under each leg of the chair (weight of ca. 10 kg). With an area of 1 cm² in each sensor (4 cm² in total), the human subject and the chair with a weight of up to 100 kg can generate a maximum loading pressure of up to 2500 kPa on each sensor. The linear capacitive response of the sensor accurately measures the weight of three healthy human subjects (60.2, 69.4, and 89.3 kg) sitting on top, as validated by the measurements from a commercial weight scale (FIG. 48). The additional tiny pressure under a large preload can also be accurately captured with a person (69.4 kg) holding a brush pot on the chair (preload pressure of ~2000 kPa) to catch dropping pens (each of 5.8 g, pressure of ~145 Pa) in sequence. The pronounced capacitive changes clearly capture and distinguish each dropping event (FIG. 6d and Supplementary Movie 5). The pressure resolution of 0.00725% under a preload of 2 MPa may outperform the commercial weight scale, human skin (~7%), and other microstructured pressure sensors previously reported in the literature.

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

1. A capacitive iontronic pressure sensor, comprising:
a top electrode layer comprising a first electrode attached to a substrate;
a bottom electrode layer comprising a second electrode, wherein the second electrode comprises a plurality of pyramidal microstructures; and
a dielectric layer positioned between the first electrode and the second electrode and comprising an ionic gel,
wherein the plurality of pyramidal microstructures forms a gradient array on the second electrode.

2. The sensor of claim 1, wherein the gradient array comprises:
a first area of pyramidal microstructures having a first height; and
a second area of pyramidal microstructures having a second height,
wherein the first height is different than the second height.

3. The sensor of claim 1, wherein the gradient array comprises:
a first area of pyramidal microstructures having a first height;
a second area of pyramidal microstructures having a second height; and
a third area of pyramidal microstructures having a third height,
wherein each of the first height, the second height, and the third height are different.

4. The sensor of claim 1, wherein each pyramidal microstructure comprises a multi-layered structure.

5. The sensor of claim 4, wherein each pyramidal microstructure comprises:
an outermost region of a first height;
an intermediate region with a second height; and
an innermost region with a third height,
wherein the first height is less than the second height, and the second height is less than the third height.

6. The sensor of claim 1, wherein the second electrode further comprises a metal sputtering layer formed on the plurality of pyramidal microstructures.

7. The sensor of claim 6, wherein the metal sputtering layer comprises gold.

8. The sensor of claim 1, wherein the sensor has a sensitivity of 33.7 kPa⁻¹ over a linear range of 1700 kPa.

9. The sensor of claim 1, wherein the sensor has a detection limit of 0.36 Pa.

10. The sensor of claim 1, wherein the sensor has a pressure resolution of 0.00725%.

11. The sensor of claim 1, wherein the sensor has a response time between 30-50 milliseconds.

12. The sensor of claim 1, wherein the first electrode comprises an indium tin oxide material.

13. The sensor of claim 1, wherein the second electrode comprises a PDMS material.

14. An electronic sensing device comprising:
a microcontroller unit;
at least one sensor of claim 1;
a non-transitory computer readable medium connected to the microcontroller unit;
a transceiver unit connected to the microcontroller unit; and
a power source.

15. The electronic sensing device of claim 14, wherein the electronic sensing device is configured to transmit collected data to an input/output device.

16. A method of making a capacitive iontronic pressure sensor, the method comprising:
forming a second electrode, comprising the steps of:
laser-ablating a second electrode template to form a plurality of cell units within the template, wherein the plurality of cell units forms a gradient array,
laser-ablating each cell unit to correspond to a pyramidal shape,
filling the second electrode template with a second electrode material, and
removing the second electrode material from the second electrode template to form the second electrode;
optionally, forming a metal sputtering layer on the second electrode;
coating a first electrode with an ionic gel to form a dielectric layer; and
positioning the dielectric layer between the first electrode and the second electrode layer to form the sensor.

17. The method of claim 16, wherein the gradient array comprises:
a first area of cell units having a first depth; and
a second area of cell units having a second depth,
wherein the first depth is different than the second depth.

18. The method of claim 16, wherein the gradient array comprises:
a first area of cell units having a first depth;
a second area of cell units having a second depth; and
a third area of cell units having a third depth,
wherein each of the first depth, the second depth, and the third depth are different.

19. The method of claim 16, wherein the pyramidal shape comprises a multi-layered shape.

20. The method of claim 19, wherein each cell unit comprises:
an outermost region of a first depth;
an intermediate region with a second depth; and
an innermost region with a third depth,
wherein the first depth is less than the second depth, and the second depth is less than the third depth.

21. (canceled)
